(19) United States
(12) Patent Application Publication
(10) Pub. No.: US 2015/0183619 A1
(43) Pub. Date: Jul. 2, 2015

(54) Dumbwaiter System

(71) Applicant: MU CO.,LTD, Busan (KR)

(72) Inventors: Min Kyung Oh, Busan (KR); Seung Yeop Oh, Busan (KR)

(73) Assignee: Mu Co., Ltd., Busan (KR)

(21) Appl. No.: 14/414,939

(22) PCT Filed: Jul. 19, 2013
(86) PCT No.: PCT/KR2013/006504

§ 371 Date: Jan. 15, 2015

(30) Foreign Application Priority Data
Jul. 23, 2012 (KR) 10-2012-0080133
Jul. 23, 2012 (KR) 10-2012-0080135

(51) Int. Cl. B66B 9/00; B66B 11/00

(52) U.S. Cl. CPC B66B 9/00; B66B 11/006

(57) ABSTRACT

The present invention relates to a dumbwaiter system which is capable of enabling users to automatically purchase and received goods in a residential area by being installed in a multi-dwelling building, and ensures the safety of the users by reducing contact with strangers and preventing crimes. To this end, a multi-stage dumbwaiter system, according to one embodiment of the present invention, comprises: a dumbwaiter having a body of which the inside is vacant the sides can be opened, and a horizontal transfer device for carrying an object inside or outside; and a home case disposed on one side of the dumbwaiter, and having a body of which the inside is vacant and the sides can be opened and a home case transfer device for carrying an object inside or outside, wherein the dumbwaiter delivers an object to the home case or receives an object from the home case.

### CROSS-REFERENCE TO RELATED APPLICATIONS

This is a US national phase of PCT patent Application No. PCT/KR2013/006504 having an International filing date of Jul. 19, 2013, which claims priority to Korean Patent Application No. 10-2012-0080133, filed on Jul. 23, 2012, and Korean Patent Application No. 10-2012-0080135, filed on Jul. 23, 2012 the entireties of which are incorporated herein by reference.

### FIELD OF THE INVENTION

The present invention relates to a dumbwaiter system, and in particular to a dumbwaiter system characterized in that when a dumbwaiter system is installed at a habitation building complex such as an apartment complex, etc. so that a predetermined object may be automatically purchased or delivered in a habitation area, a user's safety may be secured in such a way to decrease any contacts with strangers and prevent any crimes.

### BACKGROUND OF THE INVENTION

The dumbwaiter configured to transport foods or packages may be called a lift. The dumbwaiter in general may be used as a transfer device dedicated to deliver foods at a restaurant made in a structure of a single floor or double floors and may be a small-sized lift configured for the sake of transfer or transportation of other objects.

In addition, the Korean Patent Publication No. 10-2004-0076033 discloses a delivery input and output system based on network which is directed to a technology for installing a dumbwaiter at a habitation building complex such as an apartment complex, etc. and using the same for a door-to-door delivery service.

However, the above-mentioned door-to-door delivery service system has problems in the way that if a dumbwaiter with a predetermined object carried arrives at a desired floor, and the object is not carried outside by a client, the object may be lost because the dumbwaiter has only a function of transferring the object in a vertical direction. In case where a dumbwaiter system is designed so that each residence receives a predetermined object, such a residence may be open to others through the dumbwaiter system. In this case, an uninvited person may intrude into a residence space through the dumbwaiter, which may cause a critical problem.

Meanwhile, the conventional dumbwaiter is referred to as a transfer device having a simple structure for transferring a predetermined object to one space and is configured to move again after the conventional dumbwaiter moves once, completes one work and returns to the original position, so the working procedures are inefficient, and electric power consumption increases because of frequent uses.

For this reason, in order to resolve the above-mentioned problems, a corresponding technical field urgently needs to develop a technology which may overcome a limitation where a conventional dumbwaiter carries a predetermined object into one space, in such a way that one space is classified and expanded into multiple floors in vertical and horizontal directions, by means of which an object carrying inside and outside function with respect to objects may be completed through one time transfer.

In addition, according to the design of the habitation building complex, there may be two or more than two residences which each may share a sharing space such as a lift, steps, etc. at one floor. In this case, it needs to develop a technology on a dumbwaiter system which is capable of delivering a predetermined object to two or more than two residences using a single dumbwaiter.

### RELATED TECHNOLOGY DOCUMENTS

1. System for taking a parcel in and taking a parcel out based on network Korean patent publication No. 10-2004-0076033)

2. Door apparatus for dumbwaiter (Korean patent application No. 10-2005-0104094)

### BRIEF DESCRIPTION OF DRAWINGS

FIGS. 1 and 2 are views for describing a basic structure of a dumbwaiter system according to an exemplary embodiment of the present invention.

FIG. 3 is a view illustrating a multiple floor/multiple stage type dumbwaiter system according to the present invention.

FIG. 4 is a view for describing a configuration of a driving device which drives the multiple floor/multiple stage type dumbwaiter system of FIG. 3.

FIGS. 5 to 7 are views illustrating a multiple floor/multiple stage type dumbwaiter according to another exemplary embodiment of the present invention.

FIGS. 8 to 10 are views for describing an assigned method structure and a non-assigned method structure of a multiple floor/multiple stage type dumbwaiter system according to an exemplary embodiment of the present invention.

FIG. 11 is a view illustrating a rotary type dumbwaiter according to the present invention.

FIG. 12 is a view for describing a driving/control unit which drives a dumbwaiter of the rotary type dumbwaiter system of FIG. 11.

FIGS. 13 to 16 are views for describing the flow of an operation of the rotary type dumbwaiter system of FIG. 11.

FIGS. 17 to 20 are views illustrating a rotary type dumbwaiter system according to another exemplary embodiment of the present invention.

### DETAILED DESCRIPTION OF THE INVENTION

The present invention is made in an effort to improve the above mentioned problems. It is an object of the present invention to provide a dumbwaiter system characterized in that when a dumbwaiter system is installed at a habitation building complex such as an apartment complex, etc. so that a predetermined object may be automatically purchased or delivered in a habitation area, a user's safety may be secured in such a way to decrease any contacts with strangers and prevent any crimes.

In addition, it is another object of the present invention to provide a multiple floor/multiple stage type dumbwaiter system which makes it possible to perform an object transfer and process by dumbwaiter, wherein a position detection sensor and an additional device are attached to each dumbwaiter, in such a way that a multiple floor/multiple stage type dumbwaiter is configured by vertically and/or horizontally connecting two or more than two dumbwaiters including a transfer device.

In addition, it is further another object of the present invention to provide a rotary type dumbwaiter system wherein objects may be transferred to each residence using a single dumbwaiter even when the number of residences of the habitation building complex is two or more than two since the dumbwaiter of the present invention may rotate 360°.

However, the objects of the present invention are not limited to the above mentioned objects, and the unmentioned objects may be also clearly understood with reference to the following descriptions by a person having ordinary skill in the art.

To achieve the above objects, there is provided a dumbwaiter system, comprising a dumbwaiter which includes a hollow body and an openable side surface and includes a horizontal transfer device provided inside of the dumbwaiter for carrying an object inside or outside; and a home case which includes a hollow body and an openable side and includes a home case transfer device provided inside of the home case for carrying the object into or outside wherein the home case is arranged one side surface of the dumbwaiter, wherein either the dumbwaiter transfers the object into the home case or the dumbwaiter receives the object from the home case.

The multiple floor/multiple stage dumbwaiter system according to an exemplary embodiment of the present invention is characterized in that a plurality of the dumbwaiter are stacked in horizontal and vertical directions, so that the object is transferred to both ends of the straight lines which are horizontally stacked or the object is received from both ends.

The rotary type dumbwaiter system according to an exemplary embodiment of the present invention is characterized in that the home cases are formed, on the horizontal surface in multiple numbers, of first to n-th home cases (“n” represents a natural number which is two or more than two), and the dumbwaiter includes a circular plate-shaped turntable which rotates 360° in accordance with a control of the driving/control unit, a turntable top transfer device arranged on the top of the turntable, and a transfer device unit which is formed of a set of the 1 to n-th transfer devices each formed between the 1 to n-th home case and the turntable, and the object “J” is carried inside or outside in such a way that the moving direction of the turntable top transfer device on which the object “J” is placed is controlled to face the first to n-th home case by rotating the turntable in accordance with a control of the driving/control unit.

### Advantageous Effects

The dumbwaiter according to an exemplary embodiment of the present invention is advantageous in that when a dumbwaiter system is installed at a habitation building complex such as an apartment complex, etc. so that a predetermined object may be automatically purchased or delivered in a habitation area, a user's safety may be secured in such a way to decrease any contacts with strangers and prevent any crimes.

The multiple floor/multiple stage type dumbwaiter according to another exemplary embodiment of the present invention makes it possible to perform an object transfer and process by dumbwaiter, wherein a position recognition sensor and an additional device are attached to each dumbwaiter, in such a way that a single floor/multiple floor type dumbwaiter is configured by vertically and/or horizontally connecting two or more than two dumbwaiters including a transfer device.

In addition, the rotary type dumbwaiter system according to further another exemplary embodiment of the present invention is characterized in that objects may be transferred to each residence using a single dumbwaiter even when the number of residences of the habitation building complex is two or more than two since the dumbwaiter of the present invention may rotate 360°.

### MODE FOR INVENTION

The preferred exemplary embodiments of the present invention will be descried with reference to the accompanying drawings. In the course of the descriptions, the detailed descriptions of the related known functions or configuration will be omitted if it is judged that such descriptions might make unclear the subject matters of the present invention.

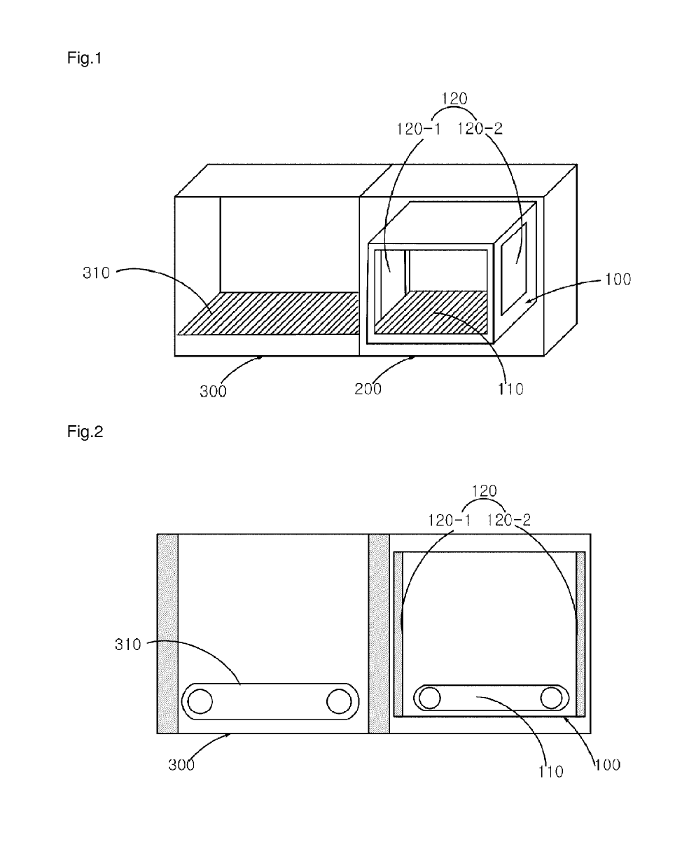

FIGS. 1 and 2 are views for describing a basic structure of a dumbwaiter system according to an exemplary embodiment of the present invention, of which FIG. 1 is a perspective view illustrating a basic structure of a dumbwaiter system, and FIG. 2 is a cross sectional view illustrating a basic structure of a dumbwaiter system.

Referring to FIGS. 1 and 2, the multiple floor dumbwaiter system includes a dumbwaiter 100, a duct 200 and a home case 300. The dumbwaiter 100 includes a horizontal transfer device 110 and a door unit 120. The door unit 120 includes a first door 120-1 and a second door 120-2. The materials of the horizontal transfer device 110 and the door unit 120 are steel, rubber, plastic, stainless, etc. which may be changed and used according to situation.

Here, the first door 120-1 is formed at one side surface contacting with the home case 300, and the second door 120-2 is formed at the opposite end where the home case 300 is formed, for the use when transferring a predetermined object when another home case is formed. Here, the first door 120-1 may be an automatic door, and may be any one of an upward or downward opening and closing type, a leftward or rightward opening and closing type, a center wise opening and closing type, a sideward opening and closing type, etc. which may be selected based on necessity.

The duct 200 may be configured in such a way that a vertical transfer device (not shown) such as a wire, a chain, a push-pull arm, etc. may be connected to a driving device (not shown) inside of the duck in order for the dumbwaiter 100 to move upward or downward. The object accommodated inside of the dumbwaiter 100 may move in the interior of the duct 200 by means of the driving device in accordance with an external control, and the dumbwaiter 100 moves toward a residence space of a user wherein any of the terminal ends of the duct 200 is installed, and the dumbwaiter 100 which has completed the transfer is positioned at the home case 300 which is installed in the residence space of the user.

The home case 300 is formed at the front end of the first door 120-1, so that the object may carried into the home case 300. When the object is completely delivered after the carrying outside work, the user can open the door (not shown) of each home case, so the home case 300 may be used as a means for securing safety. A home case transfer device 310 may be formed inside of the home case 300. The home case transfer device 310 is configured to carry the object inside of the home case 300 with the aid of the horizontal transfer device 110 formed at the dumbwaiter 100 and to carry the object outside of the home case 300.

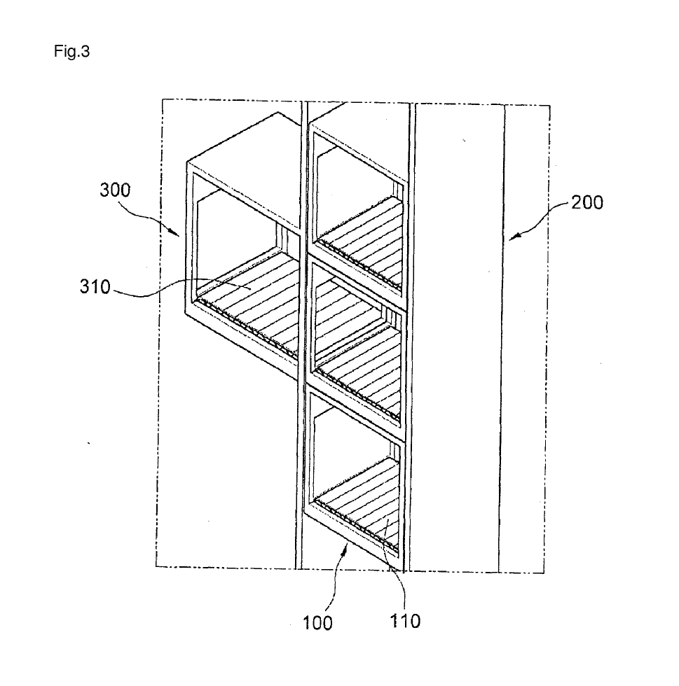

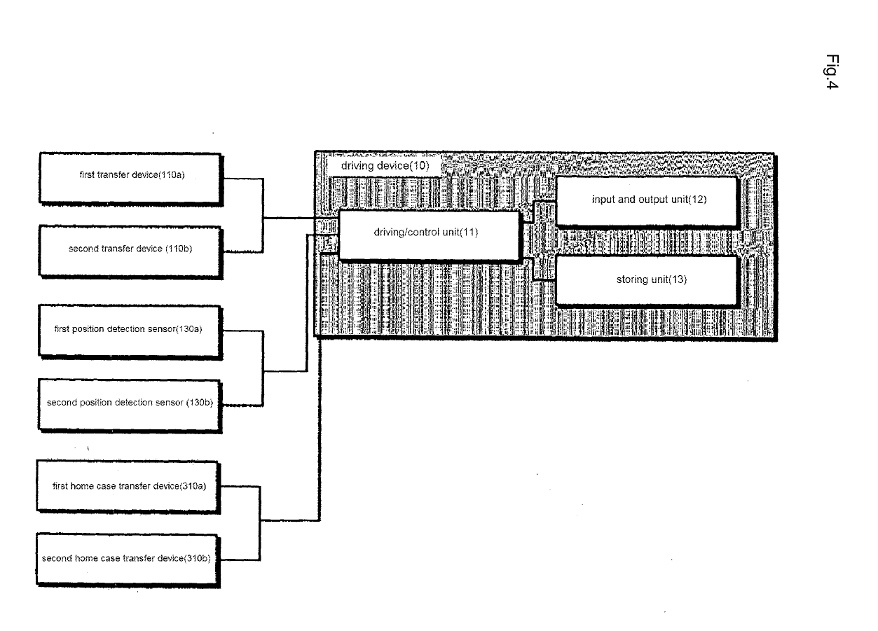

FIG. 3 is a view illustrating the multiple floor/multiple stage type dumbwaiter system according to the present invention. FIG. 4 is a view for describing a configuration of the driving device 10 which drives the multiple floor/multiple stage type dumbwaiter system 1000 of FIG. 3. Referring to FIGS. 3 and 4, the dumbwaiter system 1000 includes a first dumbwaiter 100a, a second dumbwaiter 100b, a duct 200, a first home case 300a and a second home case 300b. In the dumbwaiter system 1000 in FIG. 3, two dumbwaiters of a multiple floor shape (vertical shape) are shown, but more than two dumbwaiters may be formed in a vertical shape. Here, the first dumbwaiter 100a includes a first horizontal transfer device 110a, a first door unit 120a, and a first position detection sensor 130a, and the first door unit 120a may include a first door “a” (120a-1), and a second door “a” (120a-2) and is formed on the top of the second dumbwaiter 100b.

The first position detection sensor 130a may be formed inside of an assembly formed of pressure detection sensors arranged in a row inside of or on the upper surface of the first horizontal transfer device 110a or may be formed at the left side of the body of the first dumbwaiter 100a and at the end portion of the right side thereof or may be formed at the first door “a” (120a-1) and the second door “a” (120a-2) for thereby transferring a position detection signal of the object which moves on the first horizontal transfer device 110a to a driving/control unit 11.

The second dumbwaiter 100b includes a second horizontal transfer device 110b, a second door unit 120b, and a second position detection sensor 130b. The second door unit 120b may include a first door “b” (120b-1) and a second door “b” (120b-2). Here, the first horizontal transfer device 110a and the second horizontal transfer device 120b-2 may be transformed into a roller shape formed of a plurality of rollers as well as a belt shape, a ball shape, a chain shape, etc. and may be transformed in terms of its shape into a straight line shape as well as a round shape.

The second position detection sensor 130b may be arranged in a shape of an assembly formed of a plurality of pressure detection sensors arranged in a row inside of or on the top of the second horizontal transfer device 110b or may be formed at the left side of the body of the second dumbwaiter 100b or at the end portion of the right side thereof or may be formed at the first door “b” (120b-1) and the second door “b” (120b-2) for thereby transferring the position detection signal of the object which moves on the second horizontal transfer device 110b to the driving/control unit 11. When the first position detection sensor 130a and the second position detection sensor 130b are configured, the kinds, the number and the attaching positions of the sensors may change based on necessities.

The duct 200 may be configured in such a way that a device such as a wire, a chain, a push-pull arm, etc. may be connected inside of the duct 200 to the driving device 10 so that the first dumbwaiter 100a and the second dumbwaiter 100b arranged at the upper side and lower side can move upward and downward. The object accommodated inside of the first dumbwaiter 100a and the second dumbwaiter 100b may move upward and downward inside of the duct 200 in accordance with a control of the driving device 10. The first dumbwaiter 100a and the second dumbwaiter 100b may move into the space of the residence of the user where any of the terminal ends of the duct 200 is installed, and the dumbwaiter 100 which has finished the transfer may be positioned at the first home case 300a and the second home case 300b which are installed in the spaces of the residences of the users.

The first home case 300a provides a space for carrying the object inside or outside through the first door “a” (120a-1) of the first dumbwaiter 100a and the first door “b” (120b-1) of the second dumbwaiter 100b in accordance with the upward and downward movements on the ducts 200 of the first dumbwaiter 100a and the second dumbwaiter 100b and may include a first home case transfer device 310a.

The second home case 300b provides a space for carrying the object inside or outside through the second door “a” (120a-2) of the first dumbwaiter 100a and the first door “b” (120b-1) of the second dumbwaiter 100b in accordance with the upward and downward movements on the ducts 200 of the first dumbwaiter 100a and the second dumbwaiter 100b and may includes a second home case transfer device 310b.

As illustrated in FIG. 2, the driving/control unit 11 of the driving device 10 receives a position detection signal from the first position detection sensor 130a when an object is carried from the first home case 300a and through the first door “b” (120b-1) and the first home case transfer device 310a and into the second horizontal transfer device 110b of the second dumbwaiter 100b and controls in order for the same to move to the center of the second horizontal transfer device 110b of the object based on the above-mentioned state. Thereafter, the driving/control unit 11 controls the vertical transfer device (not shown) formed inside of the duct 200 for thereby moving the second dumbwaiter 100b upward or downward.

An another example, the driving/control unit 11 of the driving device 10 receives a position detection signal from the first position detection sensor 130a and controls for the same to move to the end portion of the second horizontal transfer device 110b of the object based on the above mentioned state and carries outside the objet through the second door “b” (120b-2) into the second home case 310b. Thereafter, the driving/control unit 11 receives a position detection signal of the object from the second position detection sensor 130b and controls in order for the same to move to the end portion of the second home case transfer device 310b of the object based on the above mentioned state.

The input and output unit 12 is configured to input a transfer command with respect to the object which is transferred into the first home case 310a and the second home case 310b for the sake of the control of the driving/control unit 1. Meanwhile, the input and output unit 12 may be configured in such a way that the input unit such as a keyboard, a mouse, etc. and the output unit such as a display in a form of a CRT, a LCD, a LED, etc. may be separately provided, but in the present invention, it is preferred that the input unit and the output unit having a touch module, etc. are integrally configured in a form of the touch screen.

The storing unit 13 is configured to store a set of transfer commands which are inputted into the input and output unit 12 and are read by the driving/control unit 11 so that the set of the transfer commands may be performed based on the automatic process by means of the driving/control unit 11.

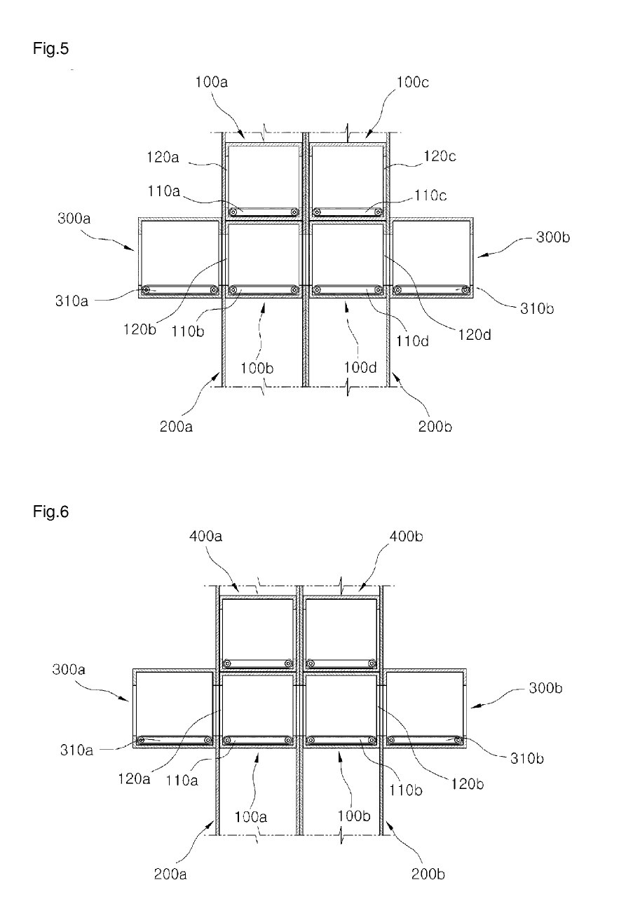

FIG. 5 is a view illustrating a multiple floor/multiple stage type dumbwaiter system according to another exemplary embodiment of the present invention. Referring to FIG. 5, the dumbwaiter system includes a first dumbwaiter 100a, a second dumbwaiter 100b, a third dumbwaiter 100c, a fourth dumbwaiter 100d, a first duct 200a, a second duct 200b, a first home case 300a, and a second home case 300b. In the multiple floor/multiple stage 2000 of FIG. 5, two or more than two dumbwaiters are stacked in a shape of vertical and horizontal combined multiple floors in vertical and horizontal directions, which may expand backward based on the direction illustrated.

Here, each of the dumbwaiters 100a to 100d may be configured to have different features. In other words, each of the dumbwaiters may be divided into a hot and cold function compartment, a waste and recycling object-dedicated compartment, etc. Each of the home cases 300a and 300b may be divided into two or more than two sections, and all the vertical side, the horizontal side and the back side may be expandable. Here, the home case 300a and 300b may be also configured to have different features.

The first dumbwaiter 100a includes a first horizontal transfer device 110a, and a first door 120a, and the second dumbwaiter 100b includes a second horizontal transfer device 110b and a second door 120b, and the third dumbwaiter 100c includes a third horizontal transfer device 110c and a third door 120c, and the fourth dumbwaiter 100d includes a fourth horizontal transfer device 110d and a fourth door 120d.

The first door 120a on the first dumbwaiter 100a and the second door 120b on the second dumbwaiter are formed at the side surface in the direction where the first home case 300a is formed, and the third door 120c on the third dumbwaiter 100c and the fourth door 120d on the fourth dumbwaiter 100d are formed at the side surface in the direction where the second home case 300b is formed.

On the top of the second dumbwaiter 100b, the first dumbwaiters 100a are stacked to form a row and are arranged inside of the first duct 200a, and on the top of the fourth dumbwaiter 100d, the third dumbwaiters 100c are stacked to form a row and are arranged inside of the second duct 200b. Meanwhile, the first dumbwaiters 100a and the third dumbwaiters 100c are arranged in one row, and the second dumbwaiters 100b and the fourth dumbwaiters 100d are arranged in one row.

Thanks to the above structure, the objects inside of the first dumbwaiter 100a, the second dumbwaiter 100b, the third dumbwaiter 100c and the fourth dumbwaiter 100d may be carried outside to the first home case 300a or the second home case 300b in accordance with a control of the driving device 10.

Namely, the first dumbwaiter 100a, the second dumbwaiter 100b, the third dumbwaiter 100c and the fourth dumbwaiter 100d are configured to carry, with the aid of the position detection sensors provided at each corresponding portion, the object inside or outside using the position detection sensors when the first dumbwaiter 100a, the second dumbwaiter 100b, the third dumbwaiter 100c and the fourth dumbwaiter 100d arrive at the position of the first home case 300a or the second home case 300b. In the first dumbwaiter 100a, the second dumbwaiter 100b, the third dumbwaiter 100c and the fourth dumbwaiter 100d, the position detection sensor installed at each of them may be a proximity sensor which may be configured in any of a photoelectric type, a pneumatic type, a magnetic type, a capacitance type, an ultrasonic wave type, etc. and may be changed into any of a photoelectric sensor, a differential transformer sensor, a step switch sensor, a capacitance sensor, etc.

FIG. 6 is a view illustrating a multiple floor/multiple stage type dumbwaiter system according to another exemplary embodiment of the present invention. Referring to FIG. 6, the multiple floor/multiple stage type dumbwaiter system includes a first dumbwaiter 100a, a second dumbwaiter 100b, a first duct 200a, a second duct 200b, a first home case 300a, a second home case 300b, a first featured dumbwaiter 400a, and a second featured dumbwaiter 400d. The multiple floor/multiple stage type dumbwaiter system is characterized in that the first featured dumbwaiters 400a are stacked on the top of the first dumbwaiter 100a and are arranged in one row inside of the first duct 200a, and the second featured dumbwaiters 400b are stacked on the top of the second dumbwaiter 100b and are arranged in one row inside of the second duct 200b. Meanwhile, the first dumbwaiters 100a and the second dumbwaiters 100b are arranged in one row, and the first featured dumbwaiters 400a and the second featured dumbwaiters 400b are arranged in one row.

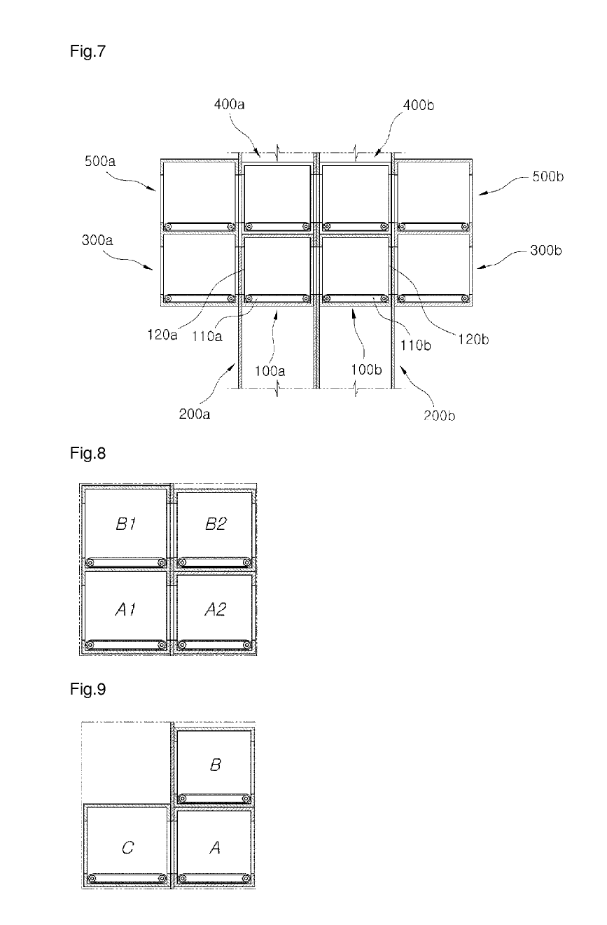

FIG. 7 is a view illustrating the multiple floor/multiple stage type dumbwaiter system according to another exemplary embodiment of the present invention. Referring to FIG. 7, the multiple floor/multiple stage type dumbwaiter system 4000 includes a first dumbwaiter 100a, a second dumbwaiter 100b, a first duct 200a, a second duct 200b, a first home case 300a, a second home case 300b, a first featured dumbwaiter 400a, a second featured dumbwaiter 400b, a first featured home case 500a, and a second featured home case 500b. The multiple floor/multiple stage type dumbwaiter system 4000 in FIG. 7 is formed in the same structure as the multiple floor/multiple stage type dumbwaiter system in FIG. 8 except for the first featured home case 500a and the second featured home case 500b.

Namely, the first featured home cases 500a are stacked on the top of the first home case 300a, and the second featured home cases 500b are stacked on the top of the second home case 300b.

Meanwhile, as an example of the featured application, in case of the food delivery-dedicated dumbwaiter at a school, a hospital, a restaurant, etc., the upper floor may be assigned as a compartment which needs to keep freshness, and the lower floor may be assigned as a compartment dedicated to the discharge of the food used.

FIGS. 8 to 10 are views for describing an assigned method structure and a non-assigned method structure of a multiple floor/multiple stage type dumbwaiter system according to an exemplary embodiment of the present invention. First, referring to FIG. 8, the home case A1 and the home case B1 are arranged in a vertical direction by two in number, and the dumbwaiter A2 and the dumbwaiter B2 are arranged in a vertical direction by two in number, so a 1:1 assignment may be made based on the featured configuration. Therefore, the home case A1 and the dumbwaiter A2 operate in pair, and the home case B1 and the dumbwaiter B2 also operate in pair. For example, the home case A1 and the dumbwaiter A2 may be assigned to perform a function of carrying inside or outside daily consumable objects such as daily necessities, door-to-door delivery objects, etc., and the home case B1 and the dumbwaiter B2 may be assigned to perform a function of carrying inside or outside wastes, a waste separation discharge, etc. Here, the horizontal direction and the vertical direction and the numbers of the home cases and the dumbwaiters may be freely set.

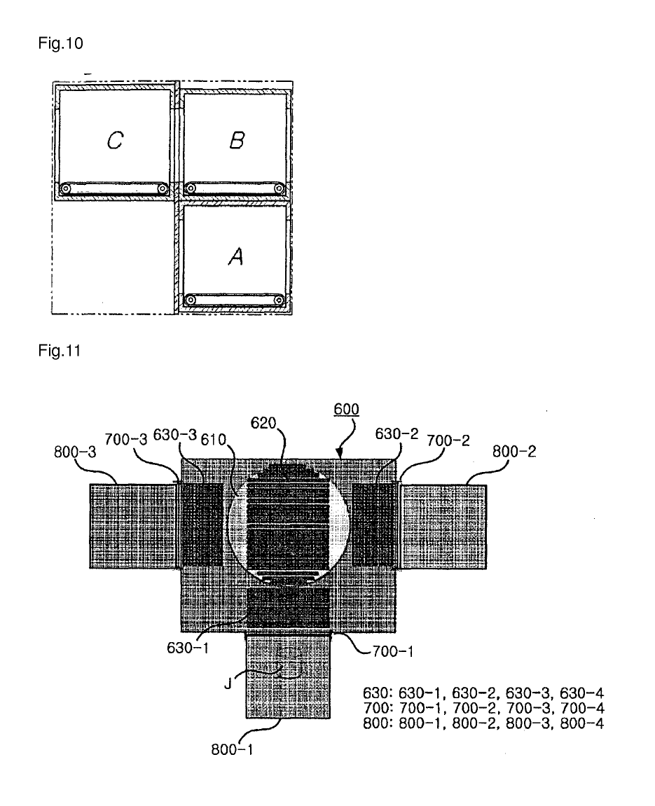

FIGS. 9 and 10 are views illustrating a non-assigned method structure wherein the number of the home case “C” is one, and the dumbwaiter “A” and the dumbwaiter “B” which are the multiple floor type dumbwaiters arrive at the requested floor. The number of the dumbwaiters formed of the dumbwaiter “A” and the dumbwaiter “B” is flexible, and the dumbwaiter “A” and the dumbwaiter “B” are configured to automatically arrive at the requested floor of the home case “C” with the aid of sensor-based recognitions.

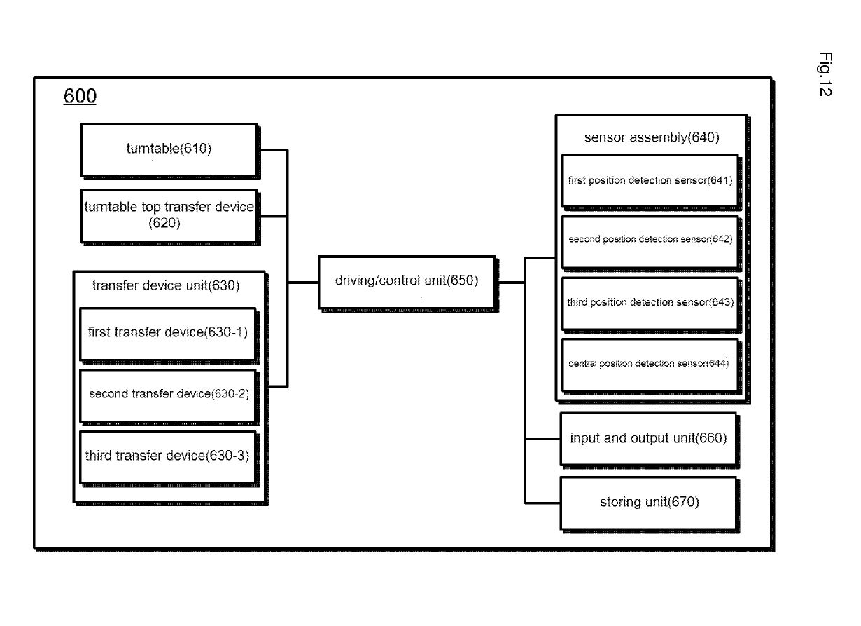

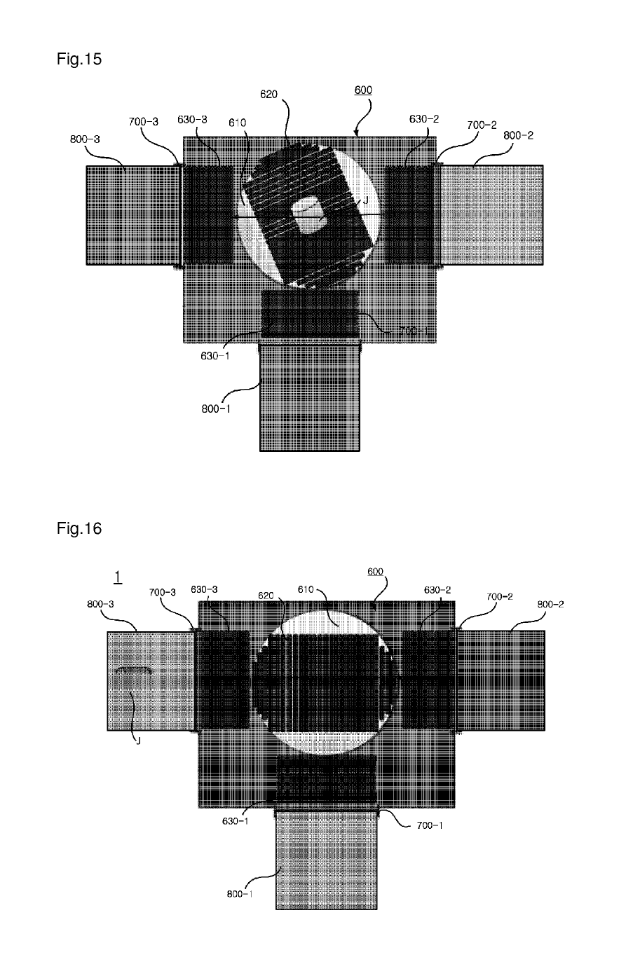

Next, the rotary type dumbwaiter system according to the present invention will be described with reference to FIGS. 11 to 20.

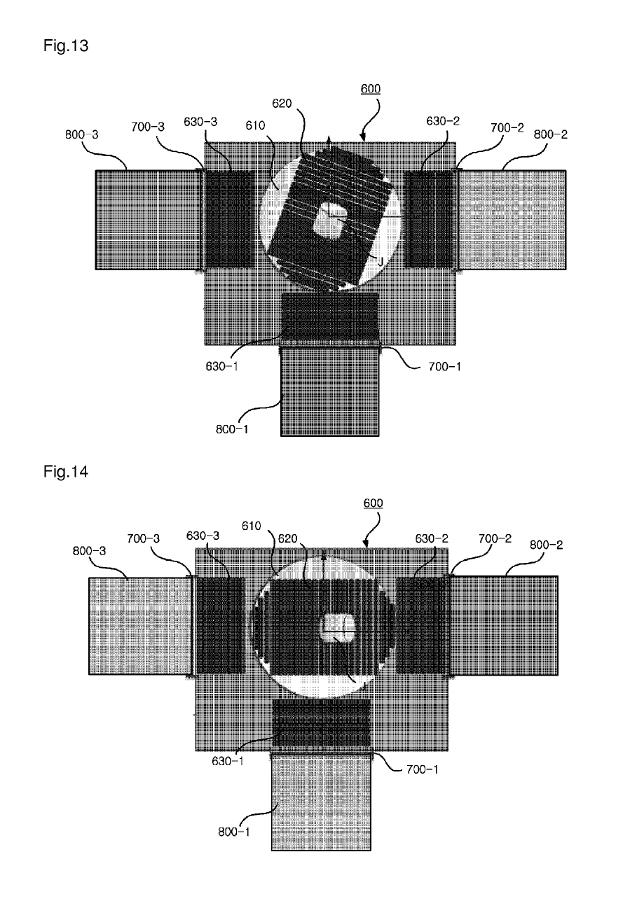

FIG. 11 is a view illustrating a rotary type dumbwaiter system according to the present invention, and FIG. 12 is a view for describing the driving/control unit 650 which drives the dumbwaiter 600 in the rotary type dumbwaiter system in FIG. 11. FIGS. 13 to 16 are views for describing the flow of operations of the rotary type dumbwaiter system of FIG. 11. Referring to FIGS. 11 to 16, the rotary type dumbwaiter system includes a dumbwaiter 600, a door assembly 700, and a home case assembly 800.

The dumbwaiter 600 includes a turntable 610, a turntable top transfer device 620 and a transfer device unit 630, a sensor assembly 640, a driving/control unit 650, an input and output unit 660 and a storing unit 670. The turntable 610, the turntable top transfer device 620 and the transfer device unit 630 may be made of steel, rubber, plastic, stainless, etc. which may change according to situations.

The turntable 610 is configured to allow the transfer direction of the turntable top transfer device 620 on the top of which the object “J” is placed, to face the transfer device, which discharges the object “J” in accordance with a control of the driving/control unit 640 in the transfer device unit 630 formed of a plurality of transfer devices, by rotating on the horizontal plane by 360° the turn table top transfer device 620 arranged on the top in accordance with a control of the driving/control unit 640.

The turntable top transfer device 620 performs a horizontal transfer function on the straight line in order for the object “J” to be carried inside or outside interlocking with the transfer device unit 630 which includes a first transfer device 630-1, a second transfer device 630-2, and a third transfer device 630-3.

For this, the turntable top transfer device 620 may be formed in a roller type which is an assembly of a plurality of rollers as illustrated in the drawings and may be transformed into a belt type, a ball type, a chain type, etc. and may be formed in a straight line shape as illustrated in the drawing as well as a round type (refer to FIG. 18).

The transfer device unit 630 includes a first transfer device 630-1, a second transfer device 630-2 and a third transfer device 630-3 and is configured to perform a horizontal transfer function on a straight line in order for the object “J” to be carried inside or outside in the same way as the turntable top transfer device 620 between the turntable top transfer device 620 and the home case unit 800 which includes a first home case 800-1, a second home case 800-2 and a third home case 800-3.

In the present exemplary embodiment of the present invention, the first transfer device 630-1, the second transfer device 630-2 and the third transfer device 630-3 are configured in a structure wherein the first transfer device 630-1, the second transfer device 630-2 and the third transfer device 630-3 are arranged on the same straight line as the turntable top transfer device 620 while the turntable 610 rotates at an angle of 90° about the quadrangle dumbwaiter 600 on the plane, and the quadrangle dumbwaiter 600 is positioned at the center of each side.

The sensor assembly 640 includes a first position detection sensor 641, a second position detection sensor 642, a third position detection sensor 643, and a central position detection sensor 644. Each sensor may be formed in a set formed of pressure detection sensors. The kinds and number of the sensor assemblies 640 may change for another application.

The first position detection sensor 641, the second position detection sensor 642 and the third position detection sensor 643 each may be arranged in a set of pressure detection sensors which are arranged in one row inside of or on the top surface of the first transfer device 630-1, the second transfer device 630-2 and the third transfer device 630-2 and are configured to transmit the position detection signals to the driving/control unit 650.

The central position detection sensor 644 may be formed in a set of pressure detection sensors which are arranged in one row inside of or on the top of the turntable top transfer device 620 for thereby transmitting a position detection signal to the driving/control unit 650.

As illustrated in FIG. 4, the driving/control unit 650 receives a position detection signal from the first position detection sensor 641 when the object “J” is carried from the first home case 600-1 into the first transfer device 630-1 through the first dumbwaiter door 700-1 and controls the same to move to the end of the first transfer device 630-1 of the object “J” based on the above state. Thereafter, when the object “J” is transferred from the first transfer device 630-1 to the turntable top transfer device 620, the driving/control unit 650 detects the above stat using the central position detection sensor 644 arranged at the turntable top transfer device 620 and controls the same to move to the central portion of the turntable top transfer device 620. Thereafter, the driving/control unit 650 rotates the turntable 610 in the normal direction (clockwise direction) by an angle of 90° and controls the turntable top transfer device 620 in order for the object “J” to be transferred to the second transfer device 630-2. Therefore, the second transfer device 630-2 receives a position detection signal from the second position detection sensor 442 of the driving/control unit 650 and allows the object “J” to be carried outside through the second dumbwaiter door 700-2 into the second home case 800-2 in accordance with a control of the driving/control unit 650 based on the above mentioned state.

Meanwhile, as illustrated in FIG. 5, the driving/control unit 650 receives a position detection signal from the second position detection sensor 642 when the object “J” is carried outside from the second home case 800-2 and through the second dumbwaiter door 700-2 and into the second transfer device 630-2 and controls the same to move to the end portion of the second transfer device 630-2 of the object “J” based on the above mentioned state. Thereafter, when the object “J” is transferred from the second transfer device 630-2 to the turntable top transfer device 620, the driving/control unit 450 controls the same to move to the central portion of the turntable top transfer device 620 according to the detection by the central position detection sensor 644 provided at the turntable top transfer device 620. Thereafter, the driving/control unit 450 rotates the turntable 410 in the reverse direction (counterclockwise direction) by an angle of 180° and controls the object “J” to be transferred to the third transfer device 630-3 by controlling the turntable top transfer device 620 in order for the object “J” to be transferred to the third transfer device 630-3. Therefore, when a position detection signal is transferred from the third position detection sensor 643 of the driving/control unit 650, the third transfer device 630-3 allows the object “J” to be carried outside through the third dumbwaiter door 700-3 into the third home case 700-3 in accordance with a control of the driving/control unit 650 based on the received position detection signal.

The input and output unit 660 is configured to input a transfer command with respect to the object “J” which is supposed to move into the first home case 800-1 to the third home case 800-3 which belong to the home case assembly 800 for the sake of a control of the driving/control unit 650. The input and output unit 660 may be configured in such a way that the input unit such as a keyboard, a mouse, etc. and the output unit formed of a display such as a CRT, a LCD, a LED, etc. are separately formed, but in the present invention, it is preferred that an input unit and an output unit having a touch module may be integrated into one touch screen.

The storing unit 670 is configured to previously store a set of transfer commands which are inputted into the input and output unit 660, and the stored set of transfer commands are read by the driving/control unit 650, so a set of the transfer commands may be automatically processed by the driving/control unit 650.

The dumbwaiter door unit 700 includes a first dumbwaiter door 700-1, a second dumbwaiter door 700-2 and a third dumbwaiter door 700-3 and may be further equipped with an automatic opening and closing function which allows the doors 700-1 to 700-3 to be automatically opened or closed in accordance with a control of the driving/control unit 650.

Each of the first dumbwaiter door 700-1, the second dumbwaiter door 700-2 and the third dumbwaiter door 700-3 may be disposed between the first transfer device 630-1 and the first home case 800-1 and between the second transfer device 630-2 and the second home case 800-2 and between the third transfer device 630-3 and the third home case 800-3, so the object “J” may be carried inside or outside by means of an automatic control or a manual work of the driving/control unit 650.

The home case unit 800 includes a first home case 800-1, a second home case 800-2 and a third home case 800-3. Each of the first home case 800-1, the second home case 800-2 and the third home case 800-3 may be formed at the front end of the first dumbwaiter door 700-1, at the front end of the second dumbwaiter door 700-2 and at the front end of the third dumbwaiter door 700-3. When the carrying outside of the object “J” into each home case is finished, the user may open the door (not shown) of each home case, which means that a predetermined safety-related means may be secured.

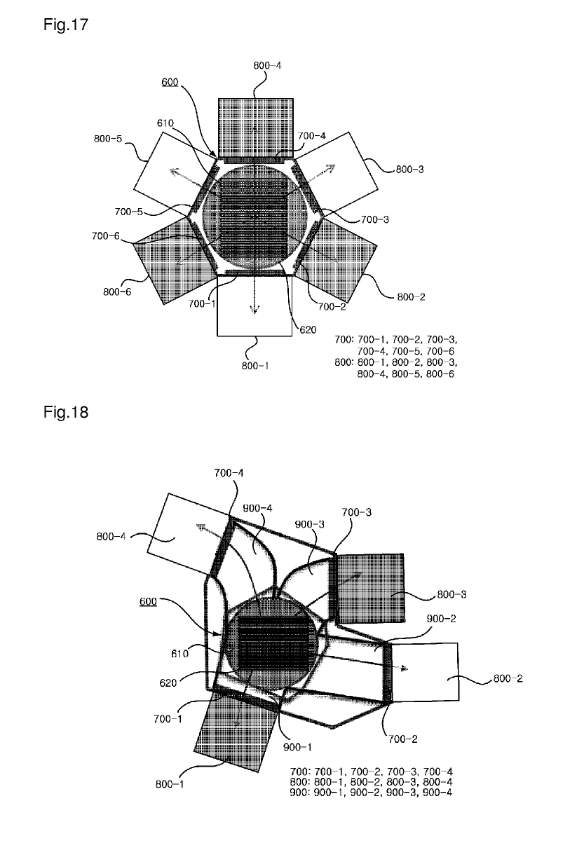

FIG. 17 is a view illustrating a rotary type dumbwaiter system according to another exemplary embodiment of the present invention. Referring to FIG. 17, in the rotary type dumbwaiter system, the dumbwaiter 600 is formed on the plane in a hexagonal shape each side of which contacts with the first dumbwaiter door 700-1 to the sixth dumbwaiter door 700-6, respectively.

In addition, the first home case 800-1 to the sixth home case 800-6 are formed at the front surfaces of the first dumbwaiter door 700-1 to the sixth dumbwaiter door 700-6.

The driving/control unit 650 controls the carrying inside and outside of the object “J” between the first home case 800-1 to the sixth home case 800-6 to be performed based on the 360° of the turntable top transfer device 620 formed on the top of the turntable 610 and the horizontal transfer of the object “J”.

FIG. 18 is a view illustrating a rotary type dumbwaiter system according to another exemplary embodiment of the present invention. Referring to FIG. 18, in the rotary type dumbwaiter system, the dumbwaiter 600 may be formed on the plane in a hexagonal shape each side of which contacts with the first dumbwaiter door 700-1 to the fourth dumbwaiter door 700-4, respectively. Meanwhile, the first home case 800-1 to the fourth home case 800-4 are formed at the front surfaces of the first dumbwaiter door 700-1 to the fourth dumbwaiter door 700-4.

Meanwhile, a first object movement passage 900-1, a second object movement passage 900-2, a third object movement passage 900-3 and a fourth object movement passage 900-4 are formed between the first dumbwaiter door 700-1 and the first home case 800-1 and between the third dumbwaiter door 700-2 and the second home case 800-2 and between the third dumbwaiter door 700-3 and the third home case 800-3 and between the fourth dumbwaiter door 700-4 and the fourth home case 800-4, respectively.

Here, the first object movement passage 900-1 may be formed in a form of a short straight line, wherein both sides of the first object movement passage 900-1 is sided by partitions. Meanwhile, there may be a predetermined difference between one side of the hexagonal dumbwaiter 600 and the first home case 800-1 on the plane contacting with the first object movement passage 900-1.

The second object movement passage 900-2 may be formed in a form of a straight line like the first object movement passage 900-1, but the second object movement passage 900-2 is formed a little bit longer in a form of a straight line than the first object movement passage 900-1, wherein both sides are sided by partitions. Here, the lengths of the partitions may be different.

The third object movement passage 900-3 and the fourth object movement passage 900-4 all are formed in curved shapes. In this case, the curvatures of the curved shapes of the third object movement passage 900-3 and the fourth object movement passage 900-4 may be different from each other.

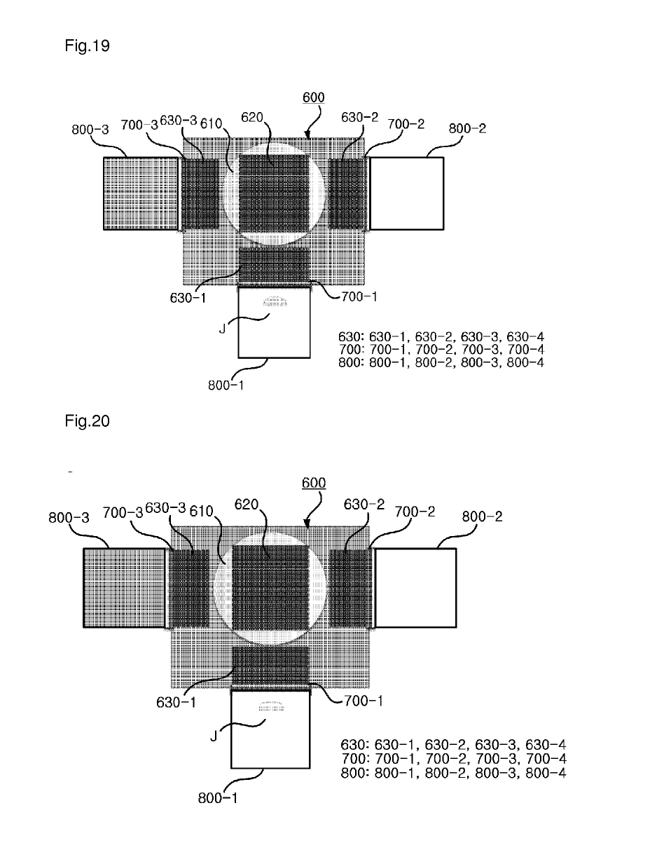

FIGS. 19 and 20 are views illustrating a rotary type dumbwaiter system according to another exemplary embodiment of the present invention. Referring to FIGS. 19 and 20, it is possible to make movable the turntable top transfer device 620 which is disposed on the top of the turntable 610 placed on the top of the dumbwaiter 600.

Namely, the turntable top transfer device 620 in FIG. 19 may be equipped with a transfer device which may move linearly in the vertical and horizontal directions between the above transfer device and the turntable 610 so as to perform a horizontal movement function on the straight line in order for the object “J” to be carried inside or outside in case where there is a predetermined space with respect to the transfer device unit 630 which includes a first transfer device 630-1, a second transfer device 630-2 and a third transfer device 630-3.

For this, a transfer device which may move linearly in the vertical and horizontal directions in a form of roller, belt, ball, chain, etc. may be provided between the turntable top transfer device 620 and the turntable 610. Namely, when the turntable top transfer device 620 in FIG. 19 approaches the first transfer device 630-1, it is possible to approach the first transfer device 630-1 as illustrated in FIG. 20 through the linear movements of the vertical, downward direction.

Thereafter, not illustrated in the drawings, the turntable top transfer device 620 may approaches the second transfer device 630-2 or the third transfer device 630-3 based on the rotations by the turntable 610 after the turntable top transfer device 620 has returned to the initial position in FIG. 19.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

We claim:

1. A dumbwaiter system, comprising:
a dumbwaiter which having a body of which the inside is vacant and the sides can be opened and includes a horizontal transfer device provided inside of the dumbwaiter for carrying an object inside or outside; and
a home case which having a body of which the inside is vacant and the sides can be opened and includes a home case transfer device provided inside of the home case for carrying the object inside or outside, wherein the home case is arranged one side surface of the dumbwaiter,
wherein either the dumbwaiter transfers the object into the home case or the dumbwaiter receives the object from the home case.

2. The system of claim 1, wherein the dumbwaiter further comprises:
a door unit disposed at one side surface for carrying the object inside or outside; and
a position detection sensor which is configured to create a position detection signal of the object which moves on the horizontal transfer device.

3. The system of claim 2, further comprising:
a driving/control unit which is configured to receive a position detection signal from the position detection sensor, to control the same to move to an end portion of the horizontal transfer device of the object based on the received position detection signal, to control the dumbwaiter inside of the duct to move upward or downward with the aid of a vertical transfer device which is provided at the duct for thereby allowing the dumbwaiter to move upward and downward, and to control the horizontal transfer device in order for the object to be carried outside to the home case.

4. The system of claim 1, further comprising:
a duck which is configured to provide a space in which the dumbwaiter is accommodated and moves upward and downward, wherein in the interior of the duct, there is provided the vertical transfer device which allowing the dumbwaiter moves upward and downward.

5. The system of claim 1, wherein the home case includes a home case door which is configured to receive the object when the object is carrying outside.

6. The system of claim 1, wherein a plurality of the dumbwaiter are stacked in horizontal and vertical directions, so that the object is transferred to both ends of the straight lines which are horizontally stacked or the object is received from the both ends.

7. The system of claim 6, wherein each dumbwaiter and each home case are used as one featured, dedicated compartment which is at least one of a hot and cold function compartment, a waste and recycling compartment.

8. The system of claim 7, wherein each dumbwaiter and each home case are matched 1:1 and are used as a featured, dedicated compartment when the dumbwaiter and the home case are engaged horizontally.

9. The system of claim 7, wherein a door is provided at one side surface contacting with the home case in each dumbwaiter, so the dumbwaiter is formed in any one type of an upward or downward opening and closing type, a leftward or rightward opening and closing type, a center wise opening and closing type, and a sideward opening and closing type.

10. The system of claim 1, wherein the home cases are formed, on the horizontal surface in multiple numbers, of first to n-th home cases (“n” represents a natural number which is two or more than two), and the dumbwaiter includes a circular plate-shaped turntable which rotates 360° in accordance with a control of the driving/control unit, a turntable top transfer device arranged on the top of the turntable, and a transfer device unit which is formed of a set of the 1 to n-th transfer devices each formed between the 1 to n-th home case and the turntable, and the moving direction of the turntable top transfer device on which the object “J” is placed is controlled to face each of the first to n-th home case by rotating the turntable in accordance with a control of the driving/control unit, whereby the object “J” is loaded into or unloaded from a plurality of home cases.

11. The system of claim 10, wherein the turntable top transfer device is configured to perform a horizontal movement function on a straight line in order for the object “J” to be carried inside or outside interlocking with the transfer device unit which includes first to n-th transfer devices in accordance with a control of the driving/control unit, and the first to n-th transfer devices are configured to perform a horizontal movement function on a straight line in order for the object “J” to be carried inside or outside interlocking with the turntable top transfer device which includes the first to n-th transfer devices in accordance with a control of the driving/control unit.

12. The system of claim 10, further comprising:
first to n-th position detection sensors which are formed of a set of pressure detection sensors in one row inside of or on the top surface of the first to n-th transfer devices for thereby transmitting a position detection signal to the driving/control unit; and
a central position detection sensor which is formed of a set of pressure detection sensors in one row inside of or on the top of the turntable top transfer device for thereby transmitting a position detection signal to the driving/control unit.

13. The system of claim 12, wherein the driving/control unit is configured to control a horizontal movement function of the first transfer device with respect to the object “J” based on a detection by the first position detection sensor when the object “J” is carried through the first dumbwaiter door among the first to n-th dumbwaiter doors into the first transfer device, to control in order for the object “J” to be transferred to the turntable top transfer device, and to control in order for the object “J” to move to a central portion of the horizontal movement radius of a straight line of the turntable top transfer device based on the detection by a central position detection sensor disposed at the turntable top transfer device.

14. The system of claim 13, wherein the driving/control unit is configured to control in order for the object “J” to be transferred to any one of the second to n-th transfer devices by controlling the turntable top transfer device after rotating the turntable in the normal direction or in the reverse direction by a predetermined angle large enough for the movement in the direction where any one of the second to n-th transfer devices is positioned.

15. The system of claim 10, wherein the turntable top transfer device is configured in any one of a roller type, a belt type, a ball type and a chain type which are a set of a plurality of rollers.
